(19) United States
(12) Patent Application Publication
(10) Pub. No.: US 2007/0065588 A1
(43) Pub. Date: Mar. 22, 2007

(54) Method of forming patterns using imprint material

(75) Inventors: Naoko Kihara, Matsudo-shi (JP); Yoshiyuki Kamata, Tokyo (JP); Satoshi Shirotori, Fuchu-shi (JP); Katsuyuki Naito, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/520,023

(22) Filed: Sep. 13, 2006

(30) Foreign Application Priority Data
Sep. 16, 2005 (JP) 2005-270148

(51) Int. Cl. B05D 3/12; B05D 3/02; B29C 71/02

(52) U.S. Cl. 427/355; 427/372.2; 427/532

(57) ABSTRACT

A method of forming patterns includes coating a toroidal substrate having a center hole with an imprint material containing a precursor of a metal oxide film, selected from the group consisting of a metal alkoxide and a metal oxide, and an ether type nonionic surfactant containing fluorine or silicon, imprinting a stamper on the imprint material to transfer patterns of protrusions and recesses of the stamper to the imprint material, and removing organic components from the imprint material through plasma processing or heat treatment to form a metal oxide film having patterns of protrusions and recesses.

### CROSS-REFERENCE TO RELATED APPLICATIONS

This application is based upon and claims the benefit of priority from prior Japanese Patent Application No. 2005-270148, filed Sep. 16, 2005, the entire contents of which are incorporated herein by reference.

### BACKGROUND OF THE INVENTION

1. Field of the Invention

The present invention relates to a method of forming patterns using an imprint material.

2. Description of the Related Art

In improving the track density of, for example, a hard disc drive (HDD), interference between the adjacent tracks has come to be a problem. In particular, how to lower fringing caused by the fringe effect of a magnetic field from the write head is a serious technical problem to be solved. A discrete track type patterned media (a DTR media) in which recording tracks are physically separated makes it possible to suppress a side erase phenomenon in recording and a side read phenomenon in reproducing and to increase markedly the density in the cross-track direction and, thus, is expected to provide a magnetic recording media capable of high density recording.

The DTR media includes a magnetic film etching type and a substrate processing type. A number of manufacturing steps are required for obtaining the DTR media of the magnetic film etching type, leading to a high manufacturing cost. Therefore, the substrate processing type DTR media, prepared by first producing a substrate having protrusions and recesses and then depositing a magnetic film by sputtering, is suitable to mass production of the DTR media. To obtain the substrate processing type DTR media, it may be used either a method in which the substrate is etched to form the patterns of protrusions and recesses or a method in which patterns of protrusions and recesses are formed on a thin film that is formed on a substrate.

As material of the thin film used in the latter method, metal oxide is suitable because of its good chemical-resistance and also mechanical strength higher than an organic material such as a polymer film. Thus, the metal oxide film is very useful as a pattern forming material. In order to form patterns of protrusions and recesses of a metal oxide film on a substrate, it is possible to employ a method disclosed in, for example, JP-A 2003-100609 (KOKAI). The method comprises coating a substrate with a solution of spin-on-glass (SOG) containing a silicon oxide component by spin coating, imprinting a stamper on the SOG film to transfer patterns of protrusions and recesses of the stamper, and forming a silicon oxide film having patterns of protrusions and recesses from SOG through removal of solvent and curing. Also, a method using a solution containing very fine particle of metal oxide or organometallic compound (such as metal alkoxide) as a precursor of the metal oxide film is being studied.

The present inventors have found that, where a substrate for a recording media having a center hole such as a hard disk, is spin-coated with the solution containing the precursor of the metal oxide film, unevenness in thickness tends to be caused easily due to striations extending from the center hole toward the outer periphery of the substrate, which may bring about defects.

In order to prevent the defects, it is conceivable to use a spin coater provided with a dispenser capable of being position-controlled at high accuracy and to discharge the solution such that the solution is not dispensed on the substrate edge facing the center hole. However, if the recording area on the surface of the recording media is to be made as large as possible in order to increase the recording density, it is necessary to use a dispenser with very high accuracy in the discharging position. Also, there comes a problem that an interface of the coated solution is produced in the vicinity of the center hole anyway, with the result that defects are caused by unevenness in thickness of the coating.

### BRIEF SUMMARY OF THE INVENTION

According to one aspect of the present invention, there is provided an imprint material comprising: a precursor of a metal oxide film selected from the group consisting of a metal alkoxide and a metal oxide; and an ether type nonionic surfactant containing fluorine or silicon.

According to another aspect of the present invention, there is provided a method of forming patterns, comprising: coating a toroidal substrate having a center hole with an imprint material containing a precursor of a metal oxide film, selected from the group consisting of a metal alkoxide and a metal oxide, and an ether type nonionic surfactant containing fluorine or silicon; imprinting a stamper on the imprint material to transfer patterns of protrusions and recesses of the stamper to the imprint material; and removing organic components from the imprint material through plasma processing or heat treatment to form a metal oxide film having patterns of protrusions and recesses.

### BRIEF DESCRIPTION OF THE SEVERAL VIEWS OF THE DRAWING

FIGS. 1A, 1B and 1C are cross-sectional views showing a method of forming patterns according to an embodiment.

### DETAILED DESCRIPTION OF THE INVENTION

The present invention will now be described in detail.

An imprint material according to an embodiment of the present invention is used in an application in which a substrate is coated with the material to which patterns of protrusions and recesses are transferred from a stamper by imprinting. The imprint material according to the embodiment of the present invention contains a precursor of a metal oxide film selected from the group consisting of a metal alkoxide and a metal oxide and an ether type nonionic surfactant containing fluorine or silicon. The imprint material according to the embodiment of the present invention is used in a form of a solution containing these components.

The metal contained in the metal alkoxide or the metal oxide used as the precursor of the metal oxide film includes, for example, Al, Ti, Sr, Ta, Nb, Ba, La, Zr, Bi and Y. It is desirable that the metal alkoxide or the metal oxide is contained in the solution in an amount of 3 to 5 wt %. The precursor of the metal oxide film available on the market in the form of a particular includes, for example, a metal organic decomposition (MOD) material available from Kojundo Chemical Laboratory CO., LTD.

The ether type nonionic surfactant containing fluorine or silicon exhibits high surface activity even if the amount thereof is small. Where other surfactant is added to the solution in a large amount, an adverse effect such as film retreat may be caused at the outer periphery. However, such a difficulty can be avoided in the case where the ether type nonionic surfactant containing fluorine or silicon is used. The ether type nonionic surfactant may be an aliphatic compound such as polyoxyethylene alkyl ether, polyoxyethylene polyoxypropylene glycol, polyoxyethylene polystyrylphenyl ether and polyether dimethylsiloxane. The ether type nonionic surfactant containing fluorine has a fluorine-substituted alkyl group. The molecular weight of the fluorine-substituted alkyl group is not particularly limited, but the molecular weight may be in a range of 33 to 100,000. If the fluorine-substituted alkyl group has a molecular weight exceeding 100,000, the surfactant comes to exhibit properties as a polymer, with the result that the viscosity of the solution tends to be affected.

The ether type nonionic surfactant containing fluorine or silicon may desirable be contained in an amount of 0.01 to 1.0 wt % based on the amount of the solution containing a metal alkoxide or a metal oxide. If the amount of the surfactant is smaller than 0.01 wt %, it fails to exhibit a sufficient effect as a surfactant. If the amount of the surfactant is larger than 1.0 wt %, components of the surfactant tend to be separated, resulting in failure to obtain a uniform film.

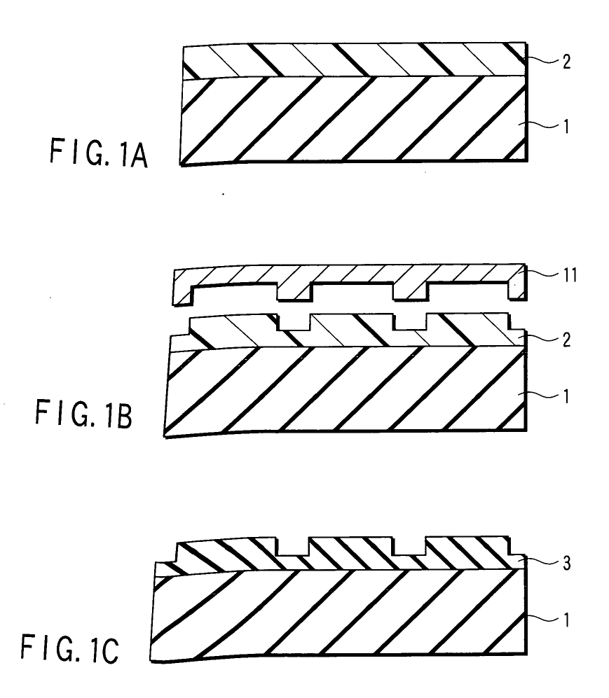

A method of forming patterns according to an embodiment of the present invention will now be described with reference to FIGS. 1A, 1B and 1C.

As shown in FIG. 1A, a toroidal substrate 1 having a center hole is coated with an imprint material 2. The substrate material is not particularly limited, but a plastic substrate, a glass substrate or a silicon substrate is generally used. It is possible to apply a surface treatment to the substrate 1 or to deposit various films on the substrate 1, as required. The imprint material 2 is in a form of a solution containing 3 to 5 wt % of a precursor of a metal oxide film selected from the group consisting of a metal alkoxide and a metal oxide and 0.01 to 1.0 wt % of an ether type nonionic surfactant containing fluorine or silicon, as described above. A method of coating the substrate 1 with the imprint material 2 includes spin coating, dipping and spraying, but it is not particularly limited. After coating, the imprint material 2 is heated to 80 to 150° C., as required, to remove a solvent.

As shown in FIG. 1B, a stamper 11 having patterns of protrusions and recesses is disposed on the imprint material 2 formed on the substrate 1, the stamper 11 is imprinted on the imprint material 2 by means of a press machine, and then the stamper 11 is removed by releasing the pressure so that the patterns of protrusions and recesses of the stamper 11 are transferred to the imprint material 2.

As shown in FIG. 1C, oxidative baking through plasma processing or heat treatment is performed to remove organic components from the imprint material 2 so that a metal oxide film 3 having patterns of protrusions and recesses is formed. It is desirable that the metal oxide film 3 formed by the oxidative baking has a thickness of 5 nm to 5 μm. If the metal oxide film 3 is thinner than 5 nm, it is difficult to form a metal oxide film free from defects such as pin holes. If the metal oxide film 3 is thicker than 5 μm, stress within the film is increased in the baking process, giving rise to difficulty that defects such as cracks may be generated in the film.

Further, in the case of manufacturing a DTR media of perpendicular recording system, for example, media films such as a soft adjacent layer, a perpendicular recording film and a protective film are formed on the substrate. In this case, the perpendicular recording films formed on the protrusions of the metal oxide film are used as recording tracks and so forth.

### EXAMPLES

The present invention will now be described in further detail based on Examples. However, the present invention is not limited to these Examples.

### Example 1

An imprint material was prepared by adding 0.02 wt % of fluorine-containing polyoxyethylene ether surfactant (trade name FTX-218, available from NEOS COMPANY LIMITED) to a solution containing aluminum oxide (trade name A1-03-P, an MOD material available from Kojundo Chemical Laboratory CO., LTD.) as a precursor of a metal oxide film. A toroidal substrate 1 having a diameter of 2.5 inches was coated with the imprint material by spin coating, and then the imprint material was baked at 120° C. for 2 minutes.

A nickel stamper 11 with patterns of protrusions and recesses having a width of 100 nm and a depth of 75 nm was disposed on the thin film of the imprint material and then the nickel stamper 11 was imprinted on the imprint material by means of a press machine under a pressure of 1,000 bars for 30 seconds so that the patterns of protrusions and recesses of the stamper 11 were transferred to the imprint material.

The substrate was put in an oxygen plasma apparatus and subjected to oxidation treatment (ashing) under the conditions of 400 W and 1 Torr to remove organic components from the imprint material so that a metal oxide film having the patterns of protrusions and recesses was formed.

The metal oxide film thus formed was observed with an optical microscope at the edge of the substrate facing the center hole to evaluate the state of the film. Table 1 shows the result of the evaluation.

### Example 2

An imprint material was prepared by adding 0.02 wt % of silicon-containing polyether modified dimethylsiloxane surfactant (trade name BYK-307, available from YK-Chemie) to a solution containing titanium oxide (trade name Ti-03-P, an MOD material available from Kojundo Chemical Laboratory CO., LTD.) as a precursor of a metal oxide film.

As in Example 1, coating a substrate with the imprint material, imprinting, and oxygen plasma processing were performed, and the metal oxide film formed was observed with an optical microscope to evaluate the state of the film. Table 1 shows the result.

### Example 3

Aluminum triisopropoxide, a metal alkoxide as a precursor of a metal oxide film, was dissolved in an amount of 5 wt % (solid content) in a (1/9) mixed solution of 2-propanol and isoamyl lactate. An imprint material was prepared by adding 0.02 wt % of fluorine-containing polyoxyethylene ether surfactant (FTX-218) to the solution and then filtering the solution with a filter of 1-micron mesh.

As in Example 1, coating a substrate with the imprint material, imprinting, and oxygen plasma processing were performed, and the metal oxide film formed was observed with an optical microscope to evaluate the state of the film. Table 1 shows the result.

### Comparative Example 1

The A1-03-P solution provided in Example 1 was used as an imprint material as it was without adding any surfactant.

As in Example 1, coating a substrate with the imprint material, imprinting, and oxygen plasma processing were performed, and the metal oxide film formed was observed with an optical microscope to evaluate the state of the film. Table 1 shows the result.

### Comparative Example 2

An imprint material was prepared by adding higher fatty acid ester as a surfactant, in place of FTX-218 used in Example 1, to the A1-03-P solution used in Example 1.

As in Example 1, coating a substrate with the imprint material, imprinting, and oxygen plasma processing were performed, and the metal oxide film formed was observed with an optical microscope to evaluate the state of the film. Table 1 shows the result.

### Comparative Example 3

The aluminum triisopropoxide solution provided in Example 3 was used as an imprint material as it was without adding any surfactant.

As in Example 1, coating a substrate with the imprint material, imprinting, and oxygen plasma processing were performed, and the metal oxide film formed was observed with an optical microscope to evaluate the state of the film. Table 1 shows the result.

As is apparent from Table 1, the metal oxide film obtained by using an imprint material containing a precursor of the metal oxide film selected from the group consisting of a metal alkoxide and a metal oxide and an ether type nonionic surfactant containing fluorine or silicon exhibits a satisfactory state.

TABLE 1

| | Result of evaluation of metal |
|---|---|
| | oxide film with optical microscope |
| Example 1 | ⊚ |
| Example 2 | ◯ |
| Example 3 | ⊚ |
| Comparative | X |
| Example 1 | |
| Comparative | X |
| Example 2 | |
| Comparative | Δ |
| Example 3 | |

⊚: unevenness in thickness was not observed;
◯: unevenness in thickness was partly observed;
Δ: slight striations were observed all over the film;
X: striations were visually observed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imprint material, comprising:
a precursor of a metal oxide film selected from the group consisting of a metal alkoxide and a metal oxide; and
an ether type nonionic surfactant containing fluorine or silicon.

2. The material according to claim 1, wherein the material is in a form of a solution containing 3 to 5% by weight of the precursor of the metal oxide film and 0.01 to 1.0% by weight of the ether type nonionic surfactant.

3. The material according to claim 1, wherein a metal contained in the precursor of the metal oxide film is selected from the group consisting of Al, Ti, Sr, Ta, Nb, Ba, La, Zr, Bi and Y.

4. The material according to claim 1, wherein the ether type nonionic surfactant containing fluorine or silicon is selected from the group consisting of polyoxyethylene alkyl ether, polyoxyethylene polyoxypropylene glycol, polyoxyethylene polystyrylphenyl ether and polyether dimethyl siloxane, each containing fluorine or silicon.

5. A method of forming patterns, comprising:
coating a toroidal substrate having a center hole with an imprint material containing a precursor of a metal oxide film, selected from the group consisting of a metal alkoxide and a metal oxide, an ether type nonionic surfactant containing fluorine or silicon, and organic components;
imprinting a stamper on the imprint material to transfer patterns of protrusions and recesses of the stamper to the imprint material; and
removing the organic components from the imprint material through plasma processing or heat treatment to form a metal oxide film having patterns of protrusions and recesses.

6. The method according to claim 5, wherein the imprint material is in a form of a solution containing 3 to 5% by weight of the precursor of the metal oxide film and 0.01 to 1.0% by weight of the ether type nonionic surfactant.

7. The method according to claim 5, wherein a metal contained in the precursor of the metal oxide film is selected from the group consisting of Al, Ti, Sr, Ta, Nb, Ba, La, Zr, Bi and Y.

8. The method according to claim 5, wherein the ether type nonionic surfactant containing fluorine or silicon is selected from the group consisting of polyoxyethylene alkyl ether, polyoxyethylene polyoxypropylene glycol, polyoxyethylene polystyrylphenyl ether and polyether dimethyl siloxane, each containing fluorine or silicon.

9. The method according to claim 5, wherein the metal oxide film has a thickness of 5 nm to 5 μm.
